(19) United States
(12) Patent Application Publication
(10) Pub. No.: US 2010/0062125 A1
(43) Pub. Date: Mar. 11, 2010

(54) Vitamin enriched snack chips

(76) Inventors: Jacek Ostrowski, Oceanside, CA (US); Rafael Ostrowski, Bay Point, CA (US)

Correspondence Address: MARK RODGERS, 1590 SAN ROQUE ROAD, SANTA BARBARA, CA, 93105, US

(21) Appl. No.: 12/283,424

(22) Filed: Sep. 10, 2008

(51) Int. Cl. A23L 1/29; A23L 1/302

(52) U.S. Cl. 426/293; 426/289

(57) ABSTRACT

A process for improving the healthfulness of common snack foods, combining dietary supplements with strong-tasting flavorings in proportions and by process steps that maintain the taste of flavored snacks and the effectiveness of the supplements.

### RELATED APPLICATIONS

Not Applicable

### FEDERALLY SPONSORED RESEARCH

Not Applicable

### SEQUENCE LISTING

Not Applicable

### BACKGROUND OF THE INVENTION

The invention relates to snack foods, such as potato chips, corn chips, crackers and the like, and in particular to enriching flavored versions of these foods with healthy dietary supplements.

Crackers, tortilla, and potato chips are often covered with a flavoring to enhance the taste. Popular flavorings include cheddar cheese, ranch, and barbecue. These flavorings add little to the nutritional value of the snack. They are loaded with unhealthy fats and high amounts of salt. A typical 28 g bag of cheese flavored tortilla chips may contain 150 calories, 8 g of fat (1.5 g of which are saturated fats), 180 mg of sodium, and 17 g of carbohydrates. There are small amounts of calcium, thiamin, and vitamin B₆.

Because of the convenience of such foods, they are consumed in large quantities. Improving the healthful aspects of these foods, while retaining their convenience and taste could have a significant impact on dietary health for consumers.

### BRIEF SUMMARY OF THE INVENTION

The invention is an enriched snack food process that includes coating the snack food with mixture of dietary supplements and flavorings. For some supplements it is necessary to cool the snacks below 280 degrees F. due to decomposition of vitamins A and B as well as to prevent the oxidation of omega fatty acids. In a preferred embodiment, the coating step further includes first coating the cooked snack with oil, and then coating the snack with the mixture in powdered form. The dietary supplement mixture preferably includes at least one vitamin. In a particular embodiment the oil is an Omega-3 fatty acid.

In another embodiment the coating step includes; first combining the mixture in powdered form with a coating agent, and then coating the snack with the coating agent. The coating agent is typically an oil or an aqueous agent.

### BRIEF DESCRIPTION OF THE DRAWINGS

The invention will be better understood by referring to the following figures.

FIG. 1 is a depiction of the novel process

FIG. 2 shows the steps of a preferred embodiment of the frying process.

FIG. 3 shows the steps of a preferred embodiment of the baking process.

FIG. 4 shows the steps of a preferred embodiment of the microwaving process.

### DETAILED DESCRIPTION OF THE INVENTION

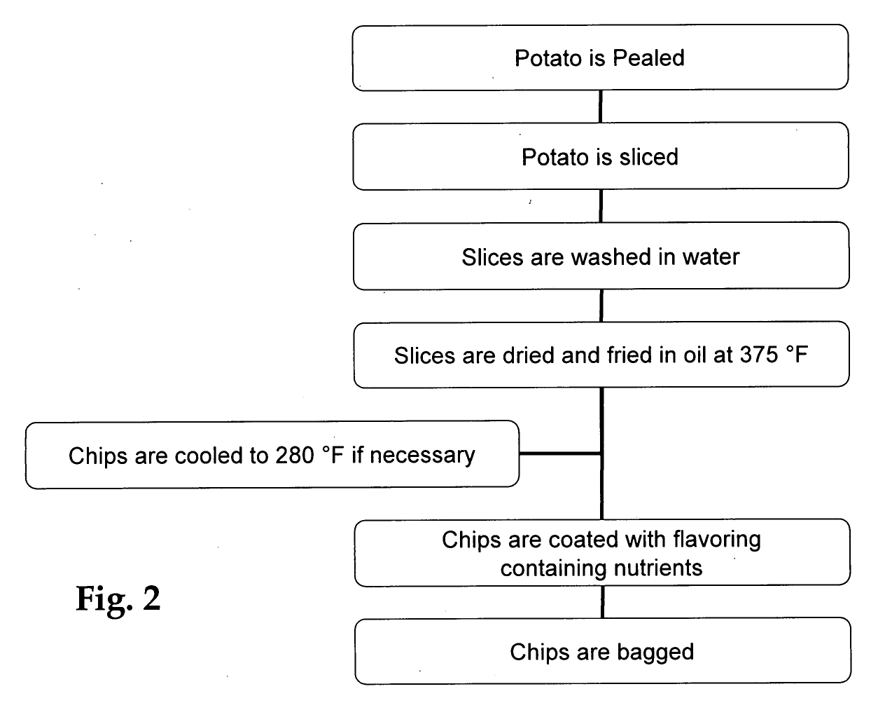

The following is a description of an exemplary process of making a potato chip from start to finish using a frying process (FIG. 2). First, potatoes may be deskinned and washed in cold water to remove particles. They are then sliced with a blade set to typically around 1/20-⅛ inch in thickness. All slices are washed in cold water to remove excess particles and starch for at least 1 minute. Excess water is removed by drying by air or other drying mechanism. Next, the slices are fried in canola or soybean oil. The frying slices are agitated several times to ensure even cooking on all surfaces. Once frying is complete, the chips are ready for flavoring. A powder mixture is sprinkled onto the chips uniformly on both sides by either tumbling or flipping. In the final step, the chips are bagged under nitrogen purge to prevent oxidation during storage.

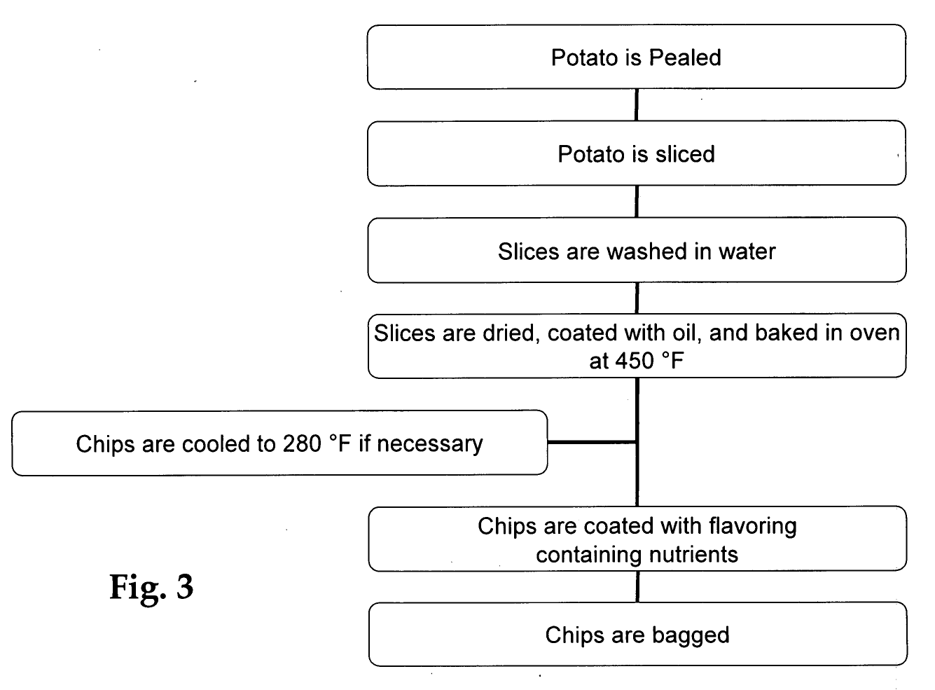

The following is a description of an exemplary process of making a potato chip from start to finish using a baking process (FIG. 3). First, potatoes may be deskinned and washed in cold water to remove particles. They are then sliced with a blade set to typically around 1/20-⅛ inch in thickness. All slices are washed in cold water to remove excess particles and starch for at least 1 minute. Excess water is removed by drying by air or other drying mechanism. The thin slices are then either sprayed or coated with oil on both sides and placed into an oven at 350-500° F. Baking times are dependent on temperature and potato slice thickness. At 450° F., the chips should be crisp after 12-16 minutes. The chips are then sprayed with oil. In the case of reduced-fat chips, a lower volume of coat oil is placed prior to flavoring application. A powder mixture is sprinkled onto the chips uniformly on both sides by either tumbling or flipping. In the final step, the chips are bagged under nitrogen purge to prevent oxidation during storage.

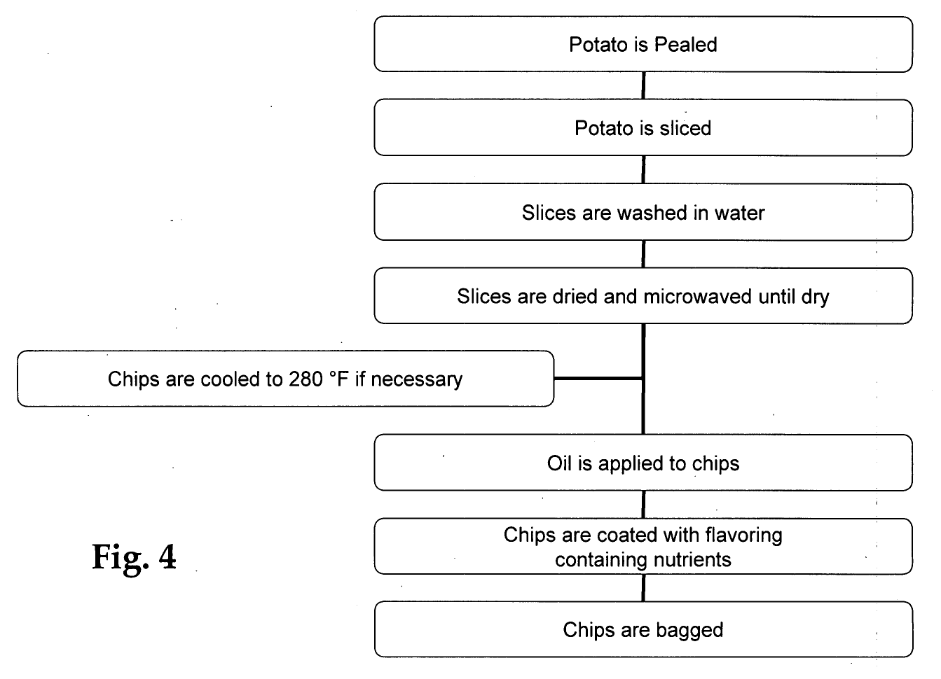

The following is a description of an exemplary process of making a potato chip from start to finish using a microwave process (FIG. 4). They are then sliced with a blade set to typically around 1/20-⅛ inch in thickness. All slices are washed in cold water to remove excess particles and starch for at least 1 minute. Excess water is removed by drying by air or other drying mechanism. The thin slices are then either sprayed or coated with oil on both sides and cooked via microwave heating. Cooking times are dependent on temperature, power of the microwave apparatus, and potato slice thickness. The chips are then sprayed with oil. In the case of reduced-fat chips, a lower volume of coat oil is placed prior to flavoring application. A powder mixture is sprinkled onto the chips uniformly on both sides by either tumbling or flipping. In the final step, the chips are bagged under nitrogen purge to prevent oxidation during storage.

As stated above, after the chips have been removed from the cookers, they may be treated with flavoring. The flavoring can be placed onto the chips by sprinkling a powder, spraying an oil/flavoring mix, or the chip can be immersed into a flavored solution. As the flavoring typically used on snack goods are mostly seasonings and salts, they are not affected negatively by the cooking temperatures. Accordingly, the flavorings are typically applied shortly after cooking, while the foods are still covered with un-dried oil or aqueous solution, thereby causing the flavorings to adhere.

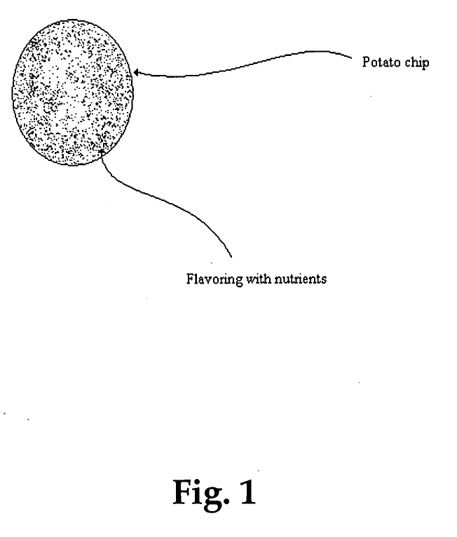

The inventors have discovered that the strong tastes of the flavorings has a previously un-recognized healthful benefit. The flavorings can mask the taste of healthful dietary supplements such as vitamins, minerals, amino acids and the like. Thus as shown in FIG. 1, adding healthful agents to the flavorings and applying the mixture to the chip has been found by the inventors to be acceptable from a taste standpoint. However some of these supplements will not tolerate the process temperatures at which the flavorings are applied in existing processing.

Thus novel alternative processing is required to add supplements to flavored snack foods such as chips. It is to be understood that although “chip” is used in an exemplary fashion, other flavored snack foods such as flavored crackers, pretzels or other similar foods should be considered within the scope of the invention if they are cooked and flavored in a matter compatible with practice of the invention.

A flavoring/supplement mixture is preferably a combination of common flavors (cheese, barbecue etc.) and nutritional supplements, such as vitamins, minerals, and other nutritional additives. The vitamins may include any combination, but are not limited to, any amount of vitamin A, thiamin, riboflavin, niacin, vitamin B₆, folic acid, biotin, pantothenic acid, vitamin B₁₂, vitamin C, vitamin D, vitamin E, and vitamin K. The minerals may include any combination, but not limited to, at any amount: calcium, magnesium, potassium, sodium, chromium (III), iron, phosphorus, iodine, zinc, selenium, copper, manganese, molybdenum, chlorine, boron, nickel, silicon, tin, and vanadium. Other nutritional additives in any combination such as, but not limited to, herbs (ginseng, ginger, ginkgo biloba, bilberry, saw palmetto, anise, chamomile, cranberry, echinacea, elderberry, fennel, garlic, goldenseal, grapeseed, milk thistle, nettle, rosemary, turmeric, valerian, and green tea) and fatty acids (Omega 3, Omega 6, Oleic acid, linoleic acid, linolenic acid, and arachidonic acid) can be added. These additives are preferably mixed homogenously with flavoring. Other additives such as, but not limited to, taurine, lutein and lycopene can be added in any combination as antioxidants.

Some vitamins such as A, C, and K are air sensitive. Fatty acids such as linoleic and linolenic acids are also sensitive to oxidation. Oxidation can render vitamins and omega fatty acids useless and in some cases can form byproducts that can be hazardous to health. The need for removal of oxygen prior to storage is essential to keeping the chips fresh. Nitrogen gas can be used as a purge to remove oxygen during the bagging process.

Temperature has an effect of increasing the rate of oxidation of vitamins and omega fatty acids and other supplements. For best results, application of vitamin enriched flavors should be applied below 280 degrees F. to limit oxidation to the most sensitive nutrients, such as vitamin A. Decomposition of vitamin due to high temperatures is also a concern. Vitamins B1 (thiamin), B2 (riboflavin), B6 (pyridoxine), and vitamin C are most susceptible of decomposition. Some supplements readily decompose at temperature in the range of most chip cooking temperatures, therefore the maximum temperature the flavorings can be deposited is 280 degrees F. for these supplements. Alternatively, if the desired chip will be flavored with vitamins or other supplements only sensitive to temperatures near or above normal cooking ranges, then the chip will not need significant cooling.

In a preferred embodiment, shown in FIGS. 2-4, a cracker, a tortilla chip, or a potato chip is cooked conventionally, and then allowed to cool below a temperature of 280 degrees F. for the preferred embodiment of depositing a wide range of supplements. The cooled product is initially sprayed with oil high in Omega fatty acids (or other nutritional fat, such as flax seed oil). A coating, consisting of a mixture of flavorings and supplements is applied either to one side or both at an even consistency. The enriched flavoring is preferably applied onto the chip or cracker by sifting the dry powder onto the oil. The oil allows the flavoring to stick onto the chip or cracker so that it will not be lost during processing, shipment, and idleness. The overall amount of nutritional additive can be added to meet daily vitamin requirements on a small bag/box (containing approximately 30 grams) or a larger bag/box (containing approximately 350 grams). This embodiment works well with baked chips, FIG. 3, as healthy oil is added after the fact, making baked chips taste and feel more like fried chips, while enhancing their healthy aspects.

In other embodiments, the flavoring/supplement can be placed onto the chips by sprinkling a powder on a chip while the cooking oil is still wet, spraying an oil/flavoring mix, or the chip can be immersed into a flavored solution. Flavoring solutions or sprays can be made by mixing the flavoring/supplement powder with an aqueous or oil solution and applying to the substrate in one step. Timing is critical if the cooking oil is used as the adhering agent as the substrate may have to cool sufficiently to not degrade certain supplements with the oil remaining wet. This may not be possible for all products.

In a particular tested embodiment, flavoring was mixed in a ratio of 4 parts flavor to 1 part multivitamin mix. The multivitamin consisted of 3500 I.U. vitamin A, 200 mg ascorbic acid (vitamin C), 400 I.U., vitamin D, 60 I.U. vitamin E, 25 μg vitamin K, 1.5 mg thiamin, 1.7 mg riboflavin, 20 mg niacin, 2 mg vitamin B6, 400 μg folic acid, 6 μg vitamin B12, 20 μg Biotin, 10 mg pantothenic acid, 162 mg dicalcium phosphate (calcium), 18 mg iron, 150 μg iodine, 100 mg magnesium oxide (magnesium), 22.5 mg zinc, 45 μg selenium, 3 mg copper, 2.5 mg manganese, 120 μg chromium, 75 μg molybdenum, 72 mg chloride, 80 mg potassium chloride (potassium), 150 μg boron, 5 μg nickel, 11 μg tin, 2 mg silicon, 10 μg vanadium, 275 μg lutein, and 300 μg lycopene. The total mass of the vitamins was 773 mg and the flavoring was 3092 mg. The ratios and exact make-up are by way of example, and other proportions may be desirable for any given flavor and supplement mix.

In the particular tested embodiment, the substrate (chip, cracker, tortilla chip, etc) after cooking was allowed to cool to 100° F. It was then treated with flax seed oil. The oil was atomized and sprayed to coat the chip. The amount of flax seed oil or other oil rich in omega fatty acids that coats each chip ranges from 5 uL to 100 uL depending on the flavor produced. Since Omeaga fatty acids have a strong fish taste it is critical to keep the volumes sprayed onto the chips below palatability. The chip was then coated with the flavor supplement mixture, this resulted in about 10 mg to 100 mg of the material being deposited on the chip of which is 2 mg to 20 mg of vitamins being deposited per chip. This was then allowed to dry. The chips deposited in the bag (10-25 chips per small bag 28 g) give a total chip bag nutrient value of 20 mg to 500 mg of vitamin mix.

We claim:

1. An enriched snack food process comprising
coating a snack with a mixture of dietary supplements and flavoring.

2. The process of claim 1 further comprising cooling a cooked snack below a temperature of 280 degrees F.

3. The process of claim 2 wherein the mixture of dietary supplements and flavoring includes elements that would degrade at temperatures above 280 degrees F.

4. The process of claim 1 wherein the coating step comprises coating the snack with the mixture in powdered form.

5. The process of claim 1 wherein the coating step comprises;
first coating the snack with oil; and
then coating the snack with the mixture in powdered form.

6. The process of claim 1 wherein the coating step comprises;
first combining the mixture in powdered form with a coating agent; and,
then coating the snack with the coating agent.

7. The process of claim 1 wherein the dietary supplement mixture includes at least one vitamin, mineral, or herbal supplement.

8. The process of claim 5 wherein the oil is an Omega-3 fatty acid.

9. The process of claim 6 wherein the coating agent is at least one of an oil or an aqueous agent.
